(19) United States
(12) Patent Application Publication
(10) Pub. No.: US 2015/0285959 A1
(43) Pub. Date: Oct. 8, 2015

(54) SOLAR RADIATION CONCENTRATORS, METHODS OF CONCENTRATING SOLAR RADIATION, AND SOLAR RADIATION CONCENTRATING PRISM LENSES

(71) Applicant: Nebula Energy Inc., Bloomfield, CT (US)

(72) Inventor: Davian A. Samuels, Bloomfield, CT (US)

(21) Appl. No.: 14/677,022

(22) Filed: Apr. 2, 2015

Related U.S. Application Data
(60) Provisional application No. 61/973,883, filed on Apr. 2, 2014.

(51) Int. Cl. G02B 3/00; G02B 7/183

(52) U.S. Cl. CPC G02B 3/0006; G02B 7/183

(57) ABSTRACT

Solar radiation concentrators, methods of concentrating solar radiation and solar radiation concentrating prism lenses are provided. The solar concentrators and methods employ an array of prism lenses. The prism lenses are made from a solar radiation transmissible material and have converging planar sides, for example, at least 3 sides, for instance, 6 sides. The planar sides the prism lenses define a refractive surface positioned to receive and refract incident solar radiation and direct at least some of the incident radiation upon a target, for example, a solar cell. The concentrator and methods may also include reflective surfaces, such as, provided by an array of reflective cavities. The reflective surfaces enhance the directing of radiation upon the target. Light diffusers and methods of fabricating solar radiation concentrators and diffusers are also disclosed.

### CROSS-REFERENCE TO RELATED APPLICATIONS

This application claims priority from pending U.S. Provisional Patent Application 61/973,883, filed on Apr. 2, 2014, the disclosure of which is included by reference herein in its entirety.

### BACKGROUND OF THE INVENTION

1. Technical Field

The present invention generally relates to the concentration of radiation, such as, solar radiation, to target devices, such as, solar cells, to enhance the capture of the energy of the radiation. Specifically, aspects of the invention employ prism lenses and reflective surfaces to refract and reflect solar energy to enhance energy capture by photovoltaic (PV) devices.

2. Description of Related Art

The capture of solar energy continues to be one of major objectives of the energy industry in the 21^{st} century. The continued development of photovoltaic devices and system are reflected in the relative reduction in the cost of photovoltaics, that is, solar cells, and the expanding use of solar panels on municipal, commercial, and residential buildings and properties.

However, the capacity to capture solar energy is inherently limited by the energy conversion efficiency of the existing technology. Though strides have been made in the photovoltaic technology to enhance the efficiency of photovoltaic devices, these devices are inherently limited in their capacity to capture solar radiation.

Aspects of the present invention have been developed to enhance the capacity of existing and future photovoltaic devices by concentrating solar radiation so that the energy of the solar radiation can be more efficiently captured.

### SUMMARY OF THE INVENTION

Aspects of the present invention provide impartments in the collection and concentration of solar radiation by employing refractive and reflective surfaces, for example, planar arrays of refractive and reflective surfaces, to concentrate solar radiation to enhance its capture. Aspects of the invention are characterized by wide capture angles and concentration. For example, aspects of the present invention overcome the limitations of current concentrators by capturing and concentrating light from as broad a range as 180 degrees, or even up to a range of 360 degrees of exposure.

Though the existing art is typically limited to capturing solar radiation from horizon to horizon, that is, over a 180-degree span, aspects of the invention can broaden that range of collection, for example, for terrestrial or extraterrestrial collection of solar energy. In one aspect, having this wide angle capture and concentration allows for the capture of solar energy even under less than ideal conditions, for example, on cloudy days or on days of low sunlight.

In another aspect, a solar concentrator is provided that overcomes the limitations of prior art by using less expensive capturing surfaces, for example, less expensive planar arrays of surfaces. In addition, aspects of the invention can provide for a more consistent and standardized design, regardless of the level of solar concentration desired. Accordingly, aspects of the invention, allow for a solar collection system that can be built to specific concentrations without changing the general design of the system. This capability is believed to be neither available nor possible with prior art solar collectors, such as, curved reflectors or Fresnel lens-type concentrators.

One embodiment of the invention a solar radiation concentrator comprising or including an array of prism lenses, each of the prism lenses comprising a solar radiation transmissible material and a plurality of converging planar sides; wherein each of the plurality of planar sides of each of the prism lenses defines a refractive surface positioned to receive and refract incident solar radiation and direct at least some of the incident radiation upon a target. In one aspect, the plurality of converging planar sides may be at least 3 converging planar sides, or may consist of 6 converging planar sides. In one aspect, the solar radiation transmissible material may be a substantially translucent plastic, such as, PMMA or acrylic, or a substantially translucent glass.

In another aspect, the array of prism lenses may be an array of contiguous prism lenses, for example, an array of contiguous prism lenses that eliminates any non-contiguous regions.

In another aspect, the solar concentrator may further include an array of reflective surfaces, wherein each of the reflective surfaces in the array of reflective surfaces is associated with one prism lens. In another aspect, a plurality of reflective surface in the array of reflective surfaces may be associated with one prism lens.

In one aspect, the target of the concentrator may be any photo-responsive device or material, for example, a photovoltaic, at least a portion of a photovoltaic array.

Another embodiment of the invention is a method for concentrating solar radiation, the method comprising or including: exposing an array of prism lenses to solar radiation, wherein each of the prism lenses comprises a solar radiation transmissible material and a plurality of converging planar sides; refracting at least some of the solar radiation with at least some of the prism lenses; and directing at least some of the refracted solar radiation upon a target. In one aspect, the plurality of converging planer sides may be at least 3 planar sides or consist of 6 planar sides.

In one aspect, the method may further comprise or including reflecting at least some of the refracted solar radiation upon the target. For example, reflecting at least some of the refracted solar radiation may be practiced by reflecting at least some of the refracted radiation with a plurality of reflective surfaces.

A further embodiment of the invention is a solar radiation concentrating arrangement comprising or including an array of prism lenses, each of the prism lenses comprising a solar radiation transmissible material and a plurality of converging planar sides, and each of the plurality of converging planar sides of each of the prism lenses defines a refractive surface positioned to receive and refract incident solar radiation and direct at least some of the incident solar radiation upon a target; and an array of reflector cavities, each of the reflector cavities having a plurality of reflective surfaces positioned to reflect at least some solar radiation diffracted by at least some of the prism lenses upon the target.

In one aspect, each of the prism lenses has a base, and wherein the base of each of the prism lenses engages adjacent bases to provide the array of contiguous prism lenses.

In another aspect, each of the plurality of converging planar sides of the prism lenses converges at an angle, for example, at an angle ranging from 30 degrees to 60 degrees, for instance, 45 degrees.

Another embodiment of the invention is a method of forming a solar radiation concentrator, the method comprising or including: providing a mold having indentations defining an array of prism lenses, each of the indentations having a plurality of converging planar sides; engaging the mold with a hardenable fluid material adapted to substantially completely fill the indentations in the mold; prior to or after disengaging the mold from the hardenable fluid material, allowing the hardenable fluid material to harden to form the array of prism lenses; wherein each of the plurality of planar sides of each of the prism lenses defines a refractive surface positioned to receive and refract incident solar radiation and direct at least some of the incident solar radiation upon a target. The hardenable fluid material may be PMMA, an acrylic, or a polycarbonate. In one aspect, the mold may be a planar mold, in another respect; the mold may be a circular cylindrical mold.

A still further aspect of the invention is a solar radiation concentrating prism lens comprising: a pyramidal main body having a plurality of converging planar sides and a base; wherein each of the plurality of converging planar sides defines a refractive surface positioned to receive and refract incident solar radiation and direct at least some of the incident radiation upon a target. In one aspect, the prism lens further includes a plurality of polygonal protections projecting from the base, for example, at least three convergent planar sides or consisting of six convergent planar sides.

In one aspect, the target may be positioned on at least one surface of at least one of the plurality of polygonal protections. In another aspect, at least one surface of at least one of the polygonal projections comprises a surface reflective to solar radiation.

These and other aspects, features, and advantages of this invention will become apparent from the following detailed description of the various aspects of the invention taken in conjunction with the accompanying drawings

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a perspective view of an electromagnetic radiation concentrator comprising an array of prism lenses according to one aspect of the invention.

FIG. 2 is a perspective view of one prism lens that may be used in the array shown in FIG. 1.

FIG. 3 is a top plan view of the prism lens shown in FIG. 2.

FIG. 4 is a front elevation view of the prism lens shown in FIG. 3 as viewed along view lines 4-4 shown in FIG. 3.

FIG. 5 is a side elevation view of the prism lens shown in FIG. 3 as viewed along view lines 5-5 shown in FIG. 3.

FIG. 6 is a bottom view of the prism lens shown in FIG. 4 as viewed along view lines 6-6 shown in FIG. 4.

FIGS. 7, 8, and 9 are front elevation views of a prism lens, similar to FIG. 4, illustrating typical paths of light rays according to aspects of the invention.

FIG. 10 is a front elevation view of a prism lens according to another aspect of the invention illustrating typical paths of light rays.

FIG. 11 is a front elevation view of a prism lens, similar to FIG. 4, having reflecting surfaces according to another aspect of the invention.

FIG. 12 is a front elevation view of a prism lens, similar to FIG. 10, having reflecting surfaces according to another aspect of the invention.

FIG. 13 is a partial front elevation view of the electromagnetic radiation concentrator shown in FIG. 1 illustrating typical paths of light rays upon a target according to an aspect of the invention.

FIG. 14 is a partial front elevation view of another electromagnetic radiation concentrator illustrating typical paths of light rays according to an aspect of the invention.

FIG. 15 is a partial front elevation view of an arrangement of the electromagnetic radiation concentrator shown in FIG. 1 and a target, illustrating typical paths of light rays upon the target according to an aspect of the invention.

FIG. 16 is a partial front elevation view of the electromagnetic radiation concentrator shown in FIG. 1 and a target, illustrating further typical paths of light rays upon the target according to an aspect of the invention.

FIG. 17 is a perspective view of an arrangement of an electromagnetic radiation concentrator comprising an array of prism lenses according to one aspect of the invention and a target.

FIG. 18 is a top plan view of a portion of the concentrator shown in FIG. 17.

FIGS. 19 through 21 are top plan views similar to FIG. 18 showing the variation in the position and shape of light concentration with varying in source location according to aspects of the invention.

FIG. 22 is a perspective view of an arrangement of an array of prism lens and an array of reflector cavities according to an aspect of the invention.

FIG. 23 is a perspective view of the array of reflector cavities shown in FIG. 22.

FIG. 24 is an exploded perspective view of an arrangement of a single prism lens and a single reflector cavity shown in FIG. 22.

FIG. 25 is a top plan view of the arrangement of a single prism lens and a single reflector cavity shown in FIG. 24.

FIG. 26 is a front elevation view of the arrangement of a single prism lens and a single reflector cavity shown in FIG. 24.

FIG. 27 is a cross sectional view of the arrangement of a single prism lens and a single reflector cavity shown in FIG. 25 as viewed along section lines 27-27 shown in FIG. 25 illustrating typical paths of light rays upon a target according to an aspect of the invention.

FIG. 28 is a partial front elevation view of an electromagnetic radiation diffuser according to another aspect of the invention, illustrating typical paths of light rays being diffused.

FIG. 29 is a cross sectional view of the arrangement of a single prism diffuser and a single reflector cavity that may be used in an array of prism diffusers and reflector cavities according to another aspect of the invention.

FIG. 30 is a perspective view of one arrangement of an array of prims lens and an array of reflector cavities according to a further aspect of the invention.

FIG. 31 is an exploded perspective view of the arrangement shown in FIG. 30.

FIG. 32A is a perspective view of an assembly of a prism lens and a reflector cavity shown in FIG. 31 and FIG. 32B is an exploded perspective view of the assembly of a prism lens and reflector cavity shown in FIG. 32A.

FIG. 33 is a front perspective view of the prism lens shown in FIG. 32B.

FIG. 34 is a right-side side elevation view of the prism lens shown in FIG. 33, the left side elevation view being a mirror image thereof, and the top plan view being a 135 degree counter-clockwise rotation thereof.

FIG. 35 is a rear perspective view of the prism lens shown in FIG. 33.

FIG. 36 is a perspective view of the reflector cavity shown in FIG. 32B.

FIG. 37 is a right-side elevation view of the reflector cavity shown in FIG. 32B, the left side elevation view being a mirror image thereof, and the top plan view being a 135 degree counter-clockwise rotation thereof.

FIG. 38 is a perspective view of an array of reflector cavities that may be used in the arrangement shown in FIG. 30 according to another aspect of the invention.

FIG. 39 is an exploded perspective view of an arrangement of a prism lens and a reflector cavity as shown in FIG. 38.

FIG. 40 is a perspective view of an arrangement that may be used to fabricate aspects of the invention according to one aspect of the invention.

FIG. 41 is a perspective view of another arrangement that may be used to fabricate aspects of the invention according to another aspect of the invention.

### DETAILED DESCRIPTION OF THE INVENTION

As described herein, aspects of the invention may be adapted for a range of electromagnetic radiation, for example, both visible light and light beyond the visible spectrum, for example, infrared and ultraviolet light. In one aspect, the devices and methods disclosed herein are uniquely adapted to capture and manipulate solar radiation, that is, visible and invisible electromagnetic radiation and its accompanying energy emitted by the sun. However, it is recognized and envisioned that aspects of the invention are not limited to capturing and manipulating sunlight, but aspects of the invention can also be adapted for use with any source of electromagnetic radiation or light, including other forms of natural light and artificial light, such as, incandescent light, fluorescent light, laser light, light-emitting diodes (LEDs), and light emitting “nano-dots,” among other sources. Accordingly, though the following discussion aspects of the invention may be disclosed with reference to the handling of solar radiation, aspects of the invention are not limited to solar radiation, but may be used for any source of electromagnetic radiation.

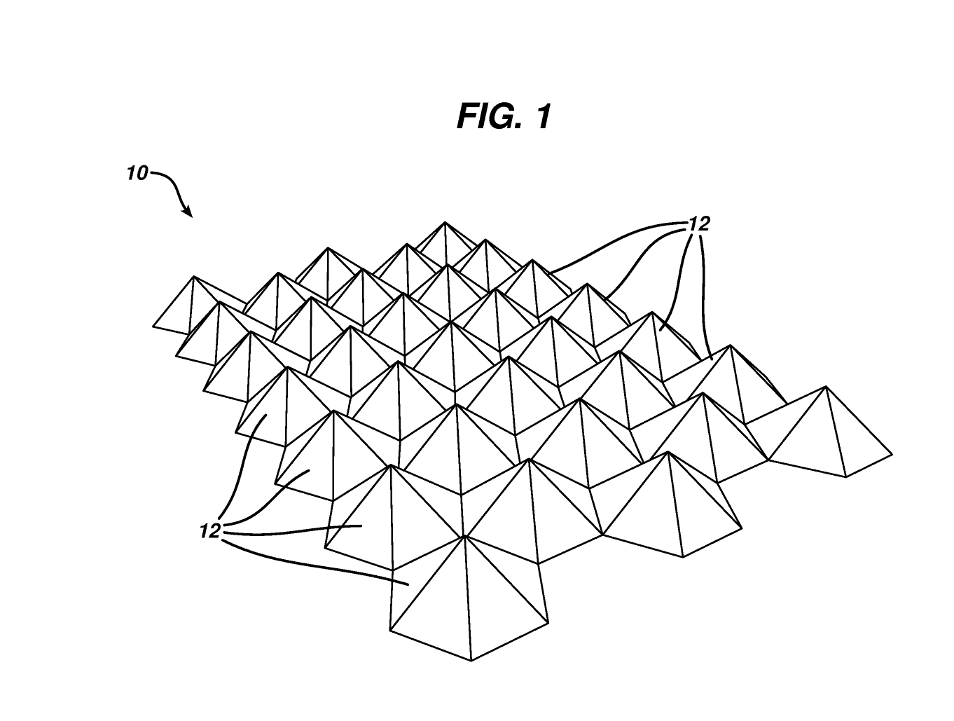

FIG. 1 is a perspective view of an electromagnetic radiation, for example, solar radiation, concentrator 10 comprising an array of prism lenses 12 according to one aspect of the invention. Concentrator 10 may typically be positioned and adapted to direct or concentrate electromagnetic radiation, for example, solar radiation, upon a target (not shown). The target may be any photosensitive material or any photo-responsive device, for example, one or more photovoltaic (PV) devices, such as, one or more “solar cells,” as known in the art. As shown in FIG. 1, concentrator 10 may typically comprise a two dimensional array of prism lenses 12, for example, a planar, two-dimensional array of prisms lenses 12; however, it is envisioned that, according to some aspects, concentrator 10 may comprise a multi-dimensional array of prism lenses 12, for example, extending in two or more planes, or a curvilinear array of prism lenses 12, for example, defining a curved surface, such as, a circular cylindrical surface.

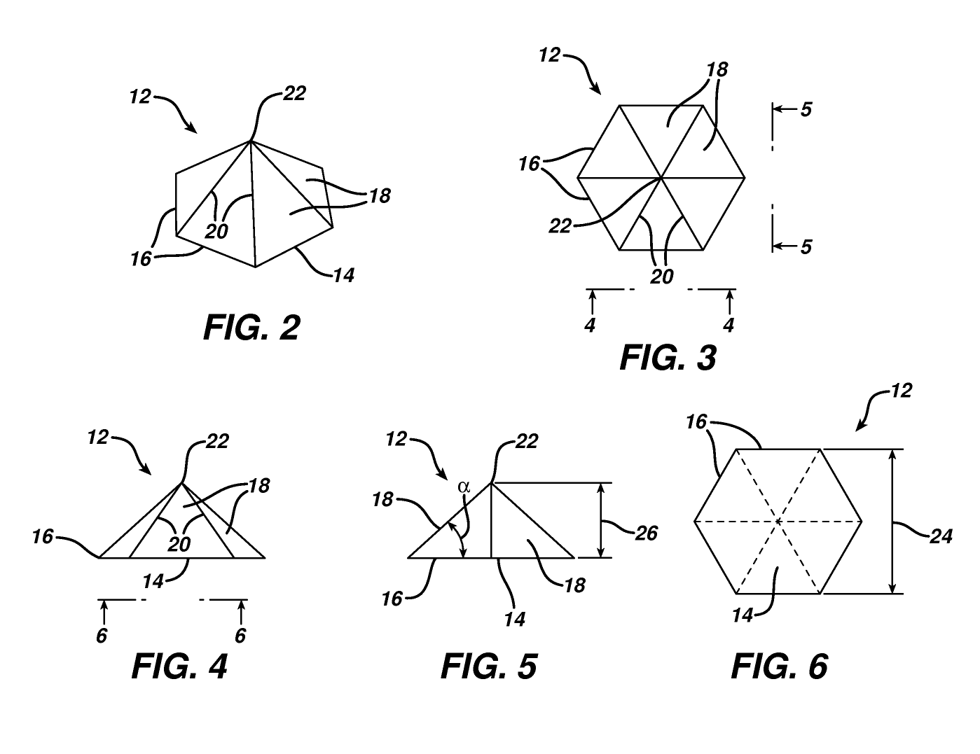

As shown, in FIG. 1, prism lenses 12 may comprise pyramidal shaped prisms, for example, six-sided pyramidal shaped lenses, though, as discussed further below, prism lenses 12 may have 3 or more planar sides. The details of one prism lens 12 are shown and described below with respect to FIGS. 2 through 6.

FIG. 2 is a perspective view of one prism lens 12 that may be used in the concentrator 10 shown in FIG. 1. FIG. 3 is a top plan view of prism lens 12 shown in FIG. 2. FIG. 4 is a front elevation view of prism lens 12 shown in FIG. 2 as viewed along view lines 4-4 shown in FIG. 3 and FIG. 5 is a side elevation view of prism lens 12 shown in FIG. 2 as viewed along view lines 5-5 shown in FIG. 3. FIG. 6 is a bottom view of prism lens 12 shown in FIG. 2 as viewed along view lines 6-6 shown in FIG. 4.

As shown in FIGS. 2 through 6, prism lens 12 may comprise a 6-side pyramid having a planar base 14 having peripheral edges 16, and planar sides 18 defined by edges 20. In one aspect, planar sides 18 may converge to an apex or point 22, though in other aspects of the invention, apex 22 may not be pointed, but may be rounded, beveled, or radiused, for example, due to the limitations of the fabrication process, or planar sides 18 may converge to a surface, for example, as generally planar surface or a radiused surface. Similarly, edges 20 of planar sides 18 may be may be rounded, beveled, or radiused, for example, due to the limitations of the fabrication process.

As shown in FIG. 5 and 6, prism lens 12 may have width 24 and a height 26, and an angle α of the orientation of converging, or convergent, sides 18 with respect to base 14. The size of prism lens 12 may vary broadly depending upon the nature of the application for which prism lens 12 is used, for example, for a “nano”-scale, “micro”-scale, or “macro”-scale application. For example, the width 24 of prism lens 12 may range from about 0.1 nanometers (nm) to about 1 meter (m). However, in some applications, the width 24 may range from about 0.1 micrometers (μm) to about 1 millimeter (mm), while in other applications, width 24 may range from about 2 mm to about 100 mm, for example, about 5 mm to about 50 mm.

Similarly, the height 26 of prism lens 12 may range from about 0.1 nanometers (nm) to about 1 meter (m). However, in some applications the height 26 may range from about 0.1 micrometers (μm) to about 1 millimeter (mm), while in other applications, height 26 may range from about 2 mm to about 100 mm, for example, about 5 mm to about 50 mm.

The angle α of the orientation of sides 18 with respect to base 14 may also vary. In some aspects, angle α may vary from about 5 degrees to about 85 degrees, but typically angle α ranges from about 30 degrees to 60 degrees, for example, between about 40 degrees and about 50 degrees, such as, about 45 degrees.

According to aspects of the invention, the material of prism lens 12 may be at least partially transparent to the electromagnetic radiation begin handled, for example, visible light, such as, sunlight. Preferably, the material for prism lens 12 may be substantially completely transparent to the radiation being handled. In one aspect, prism lens 12 may be made from a glass, for example, optical glass, tempered glass, heat treated glass, or their equivalent. In another aspect, prism lens 12 may be made from a plastic, for example, a poly methyl methacrylate (PMMA), an acrylic, a polycarbonate (PC), such as, LEXAN polycarbonate; a polyester; a fluorocarbon; a polyimide; or a polyethersulfone, among other at least partially transparent plastics or polymers that may be used to provide aspects of the invention.

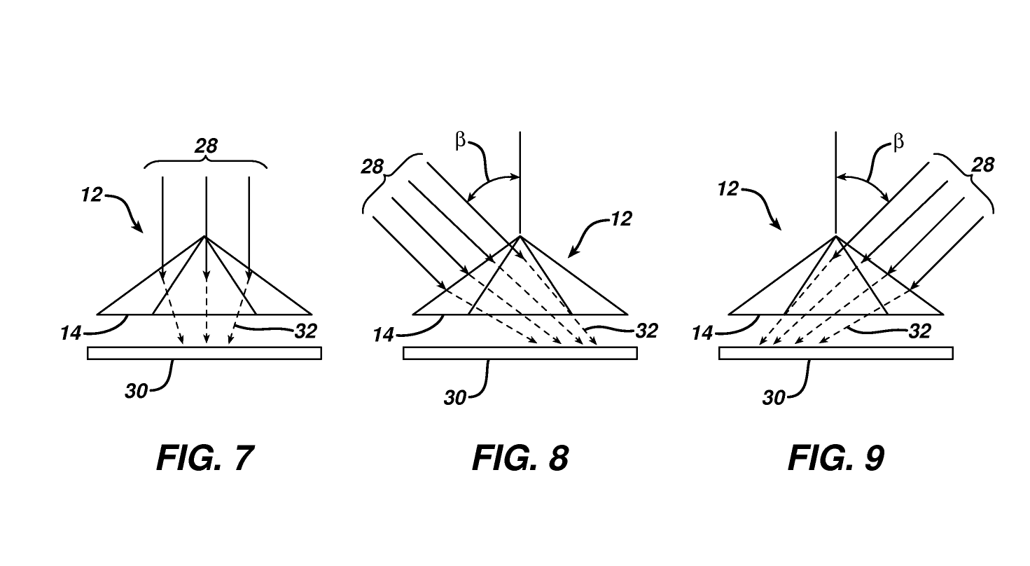

FIGS. 7, 8, and 9 are front elevation views of prism lens 12, similar to FIG. 4, illustrating typical paths of light rays according to aspects of the invention being directed on a target 30. (Though in the following discussion the expression “light rays” may be used, it is envisioned aspects of the invention are not limited to the handling of visible light. In some aspects, any form of electromagnetic radiation that can be refracted by prism lens 12 may be handled by prism lens 12 and the prism lenses disclosed herein.) As shown in FIG. 7, light rays 28, for example, solar radiation, when directed substantially perpendicular to the plane of base 14, strike sides 18 of prism lens 12 and, due the shape and material of prism lens 12 are refracted as refracted light rays 32 directed to target 30. According to aspects of the invention, target 30 may be a photon sensitive receiver, for example, photovoltaic material or a photo-responsive device, or a least a portion or a photovoltaic array of photovoltaic material. For example, in one aspect, target 30 may be one or more polycrystalline photovoltaic cells, monocrystalline photovoltaic cells, or amorphous photovoltaic cells, though other conventional photovoltaic materials may be used with aspects of the invention.

As shown in FIGS. 8 and 9, according to aspects of the invention, light rays 28 may be directed upon prism lens 12 at an oblique angle β, for example, at an angle that is not substantially perpendicular to the plane of base 14. According to aspects of the invention, light rays 28 at angle βmay strike sides 18 of prism lens 12 and, due the shape and material of prism lens 12, are refracted as refracted light rays 32 directed to target 30. According to aspects of the invention, the angle of orientation β of light rays 28 may vary broadly while prism lens 12 still captures and directs at least some energy of light rays 28 upon target 30. For example, angle of orientation β of light rays 28 may range from minus 120 degrees to 120 degrees, and direct at least some light rays onto target 30. (The negative direction of angle β is shown in FIG. 8). However, typically, angle of orientation β of light rays 28 may range from −90 degrees to 90 degrees and direct at least some light rays onto target 30.

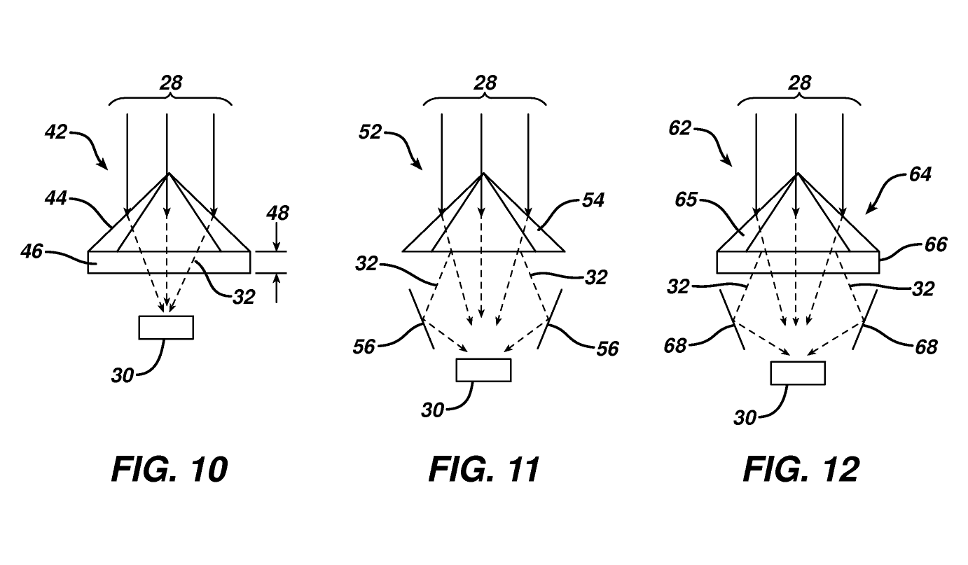

FIG. 10 is front elevation view of a prism lens 42 according to another aspect of the invention illustrating typical paths of light rays according to aspects of the invention. As shown in FIG. 10, according to this aspect, prism lens 42 may include an upper portion 44, for example, sized and shaped similar to prism lens 12 shown in FIGS. 2-6, and a lower portion or substrate 46. Lower portion 46 may have substantially the same shape as base 14 shown in FIGS. 2-6, for example, lower portion 46 may comprise substantially a projection of base 14. Lower portion 46 may have a thickness 48 ranging from about 0.1 nm to about 100 mm, but typically has a thickness 48 ranging from about 1 mm to about 20 mm. Lower portion or substrate 46 may comprise the same material as upper portion 44. In addition, upper portion 44 and lower portion 46 may be integrally fabricated, for example, molded as a single part.

FIG. 11 is a front elevation view of an arrangement 52 of a prism lens 54, for example, similar to prism lens 12 shown in FIGS. 2 through 6, and reflecting surfaces 56 according to another aspect of the invention. As shown in FIG. 11, one or more reflective surfaces 54 may be provided, for example, beneath prism lens 54, and positioned and oriented to assist in directing refracted light rays 32 toward target 30. According to aspects of the invention, the number of reflective surfaces 56 may comprise 3 or more surfaces, for example, corresponding to the number of edges 16 (see FIGS. 2 through 6) of prism lens 54. Reflective surfaces 56 may comprise any material at least partially reflective to the light ray 32 refracted by prism lens 54. However, in one aspect, reflective surfaces 56 may typically be substantially completely reflective to light ray 32. In one aspect, the one or more reflective surfaces 56 may be made from any conventional reflective material, for example, a polyethylene terephthalate (PET) sheet, such as, a MYLAR® PET sheet, having a reflective film, for instance, a metallized or dielectric reflective film (for example, aluminum, silver, or gold, for instance, deposited by vapor deposition), or any polymeric film, for instance, having a metallized reflective film, or a glass having a reflective film, for instance, a metalized film, or their equivalent.

FIG. 12 is front elevation view of an arrangement 62 of a prism lens 64, for example, similar to prism lens 42 shown in FIG. 10, having an upper portion 65, a lower portion 66, and reflecting surfaces 68 according to another aspect of the invention. The one or more reflective surfaces 68 are positioned and oriented to assist in directing refracted light rays 32 toward target 30. According to aspects of the invention, the number of reflective surfaces 68 may comprise 3 or more surfaces, for example, corresponding to the number of edges 16 (see FIGS. 2 through 6) of prism lens 64. Reflective surfaces 68 may comprise the same reflective material as reflective surfaces 56 shown in FIG. 11.

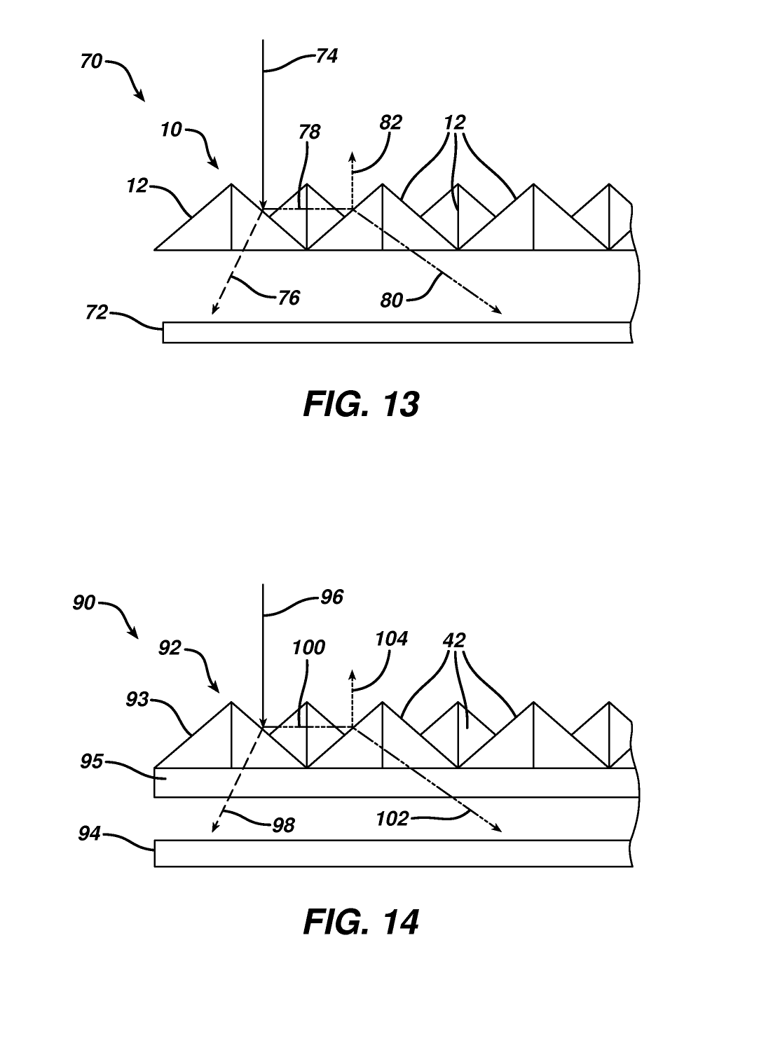

FIG. 13 is a partial front elevation view of an arrangement 70 of the electromagnetic radiation concentrator 10 shown in FIG. 1 illustrating typical paths of light rays upon a target 72 according to an aspect of the invention. As shown in FIG. 13, concentrator 10 may include an array of prism lenses 12, for example, as shown and described with respect to FIGS. 2 through 6. Target 70 may be any one or more of the targets referenced previously, for example, a photovoltaic material, or a least a portion or a photovoltaic array of photovoltaic material.

As shown in FIG. 13, according to an aspect of the invention, a representative incident radiation ray 74, for example, a ray of sunlight, contacts and is refracted by a lens prism 12 of concentrator 10 producing at least one refracted radiation ray 76. Refracted ray 76 is directed to target 72. In addition to refracting the incident ray 74, prism lenses 12 may also reflect incident ray 74 to produce one or more reflected rays 78 of radiation. According to aspects of the invention, the reflected ray 78 may contact one or more adjacent prism lenses 12 and produces one or more further refracted rays 80 and one or more reflected rays 82. Accordingly, according to aspects of the invention, the prism lenses 12 of concentrator 10 may repeatedly refract and reflect incident rays 74 and reflected incident radiation rays 78 to produce multiple refracted rays 76 and 80 directed upon target 72. It is to be understood that the refraction and reflection of incident ray 74 shown in FIG. 13 represents only a single example of the numerous rays of electromagnetic radiation, for example, sunlight, that may typically impact concentrator 10 and produce numerous multiple refracted rays 76 and 80 upon target 72.

FIG. 14 is a partial front elevation view of an arrangement 90 of an electromagnetic radiation concentrator 92 illustrating typical paths of light rays upon a target 94 according to an aspect of the invention. As shown in FIG. 14, concentrator 10 may include an array of prism lenses 42, for example, as shown and described with respect to FIG. 10, having an upper portion 93 and a lower portion or substrate 95. In one aspect, the upper portions 93 of prism lenses 42 may be mounted to one or more lower portions 95. Target 94 may be any one or more of the targets referenced previously, for example, a photovoltaic material, or a least a portion or a photovoltaic array of photovoltaic material.

As shown in FIG. 14, and in a fashion similar to arrangement 70 shown in FIG. 13, according to an aspect of the invention, a representative incident radiation ray 96, for example, a ray of sunlight, contacts and is refracted by a lens prism 42 of concentrator 92 producing at least one refracted radiation ray 98. Refracted ray 98 is directed to target 94. In addition to refracting the incident ray 96, prism lenses 42 may also reflect incident ray 96 to produce one or more reflected rays 100 of radiation. According to aspects of the invention, the reflected ray 100 may contact one or more adjacent prism lenses 42 and produces one or more further refracted rays 102 and one or more reflected rays 104. Accordingly, according to aspects of the invention, the prism lenses 42 of concentrator 92 may repeatedly refract and reflect incident rays 96 and reflected incident radiation rays 100 to produce multiple refracted rays 98 and 102 directed upon target 94. Again, it is to be understood that the refraction and reflection of incident ray 96 shown in FIG. 14 represents only a single example of the numerous rays of electromagnetic radiation, for example, sunlight, that may typically impact concentrator 92 and produce numerous multiple refracted rays 98 and 102 upon target 94.

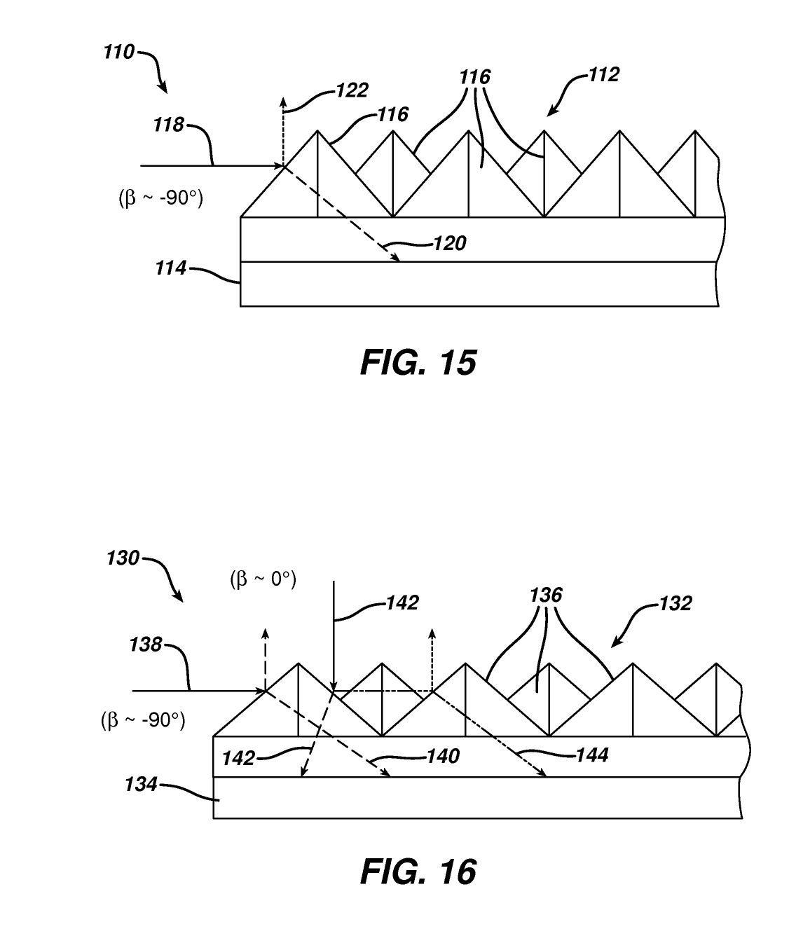

FIG. 15 is a partial front elevation view of an arrangement 110 of an electromagnetic radiation concentrator 112 illustrating further paths of light rays upon a target 114 according to an aspect of the invention. In the aspect of the invention shown in FIG. 15, target 114 may abut concentrator 112, for example, concentrator 112 may overlay or otherwise be in contact with target 114. As shown in FIG. 15, concentrator 112 may include an array of prism lenses 116, for example, as shown and described with respect to FIG. 10, having an upper portion 44 and a lower portion or substrate 46 (see FIG. 10). In one aspect, the upper portions of prism lenses 116 may be mounted to one or more lower portions. Target 114 may be any one or more of the targets referenced previously, for example, a photovoltaic material, or a least a portion or a photovoltaic array of photovoltaic material.

As shown in FIG. 15, according to an aspect of the invention, concentrator 112 having prism lenses 116 may capture and redirect radiation, for example, sunlight, incident upon concentrator 112 from a broad range of directions and direct the radiation upon target 114. For example, a representative incident radiation ray 118, for example, a ray of sunlight, directed substantially parallel to the bases of prism elements 116 (for example, having an incident angle β (see FIGS. 8 and 9) of approximately negative 90 degrees) may contact and be refracted by a lens prism 116 of concentrator 112 producing at least one refracted radiation ray 120 directed to target 114. In addition to refracting the incident ray 118, prism lenses 116 may also reflect incident ray 122. According to aspects of the invention, prism lenses 116 of concentrator 112 may capture even light rays directed at incident angles approaching, and possibly exceeding, an incident angle β of plus or minus 90 degrees, and all angles between those extremes. Again, it is to be understood that the refraction and reflection of incident ray 118 shown in FIG. 15 represents only a single example of the numerous rays of electromagnetic radiation, for example, sunlight, that may typically impact concentrator 112 and produce numerous multiple refracted rays 120 upon target 114.

FIG. 16 is a partial front elevation view of an arrangement 130 of an electromagnetic radiation concentrator 132 illustrating further paths of light rays upon a target 134 according to an aspect of the invention. In the aspect of the invention shown in FIG. 16, target 134 may abut concentrator 132; for example, concentrator 132 may overlay or otherwise be in contact with target 134. As shown in FIG. 16, concentrator 132 may include an array of prism lenses 136, for example, as shown and described with respect to FIG. 10, having an upper portion 44 and a lower portion or substrate 46 (see FIG. 10). In one aspect, the upper portions of prism lenses 136 may be mounted to one or more lower portions. Target 134 may be any one or more of the targets referenced previously, for example, a photovoltaic material, or a least a portion or a photovoltaic array of photovoltaic material.

As shown in FIG. 16, according to an aspect of the invention, concentrator 132 having prism lenses 136 may capture and redirect radiation, for example, sunlight, incident upon concentrator 132 from a broad range of directions and direct the light upon target 134. As shown in FIG. 16, a representative incident radiation ray 138, directed substantially parallel to the base of prism elements 136 (for example, having an incident angle β (see FIGS. 8 and 9) of approximately negative 90 degrees) may contact and be refracted by a lens prism 136 of concentrator 132 producing at least one refracted radiation ray 140 directed to target 134. At substantially the same time, a representative incident radiation ray 142, directed substantially perpendicular to the base of prism elements 136 (for example, having an incident angle β of approximately 0 degrees) may contact and be refracted by prisms lens 136 of concentrator 132 producing at least one refracted radiation ray 142 and 144 (via reflection and refraction as described with respect to FIGS. 13 and 14) directed to target 134. Again, it is to be understood that the refraction and reflection of incident rays 138 and 142 shown in FIG. 16 represent only single examples of the numerous rays of electromagnetic radiation, for example, sunlight, that may typically impact concentrator 132 and produce numerous multiple refracted rays 140, 142, and 144 upon target 134.

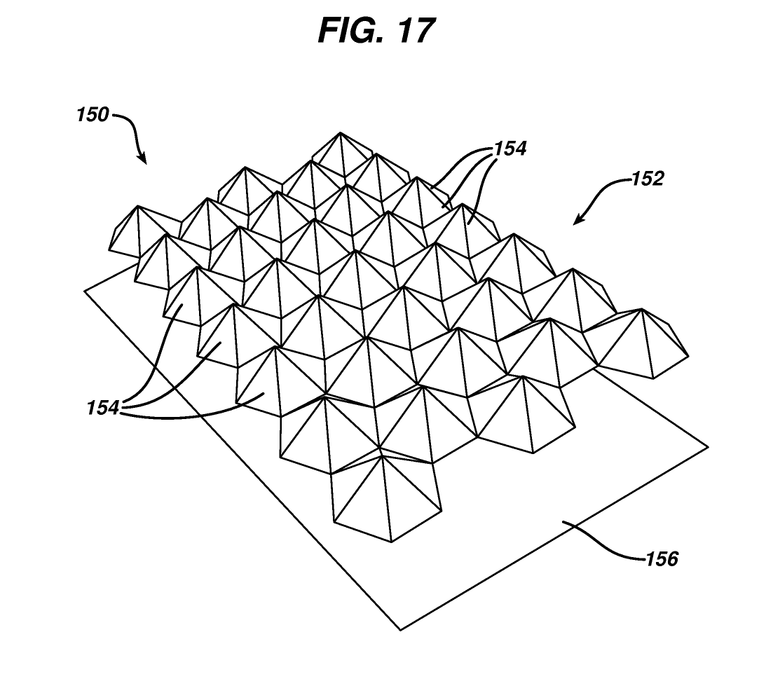

FIG. 17 is a perspective view of an arrangement 150 of an electromagnetic radiation concentrator 152 comprising an array of prism lenses 154 and a target 156 according to one aspect of the invention. Prism lenses 154 may comprise prism lenses similar to prism lenses 12 or 42 disclosed herein. Target 156 may be any one or more of the targets referenced previously, for example, a photovoltaic material, or a least a portion or a photovoltaic array of photovoltaic material. According to aspects of the invention, concentrator 152 can be used to direct the path of incoming radiation (not shown), for example, sunlight, upon target 156 to, among other things, enhance the collection of the energy of the radiation incident upon target 156.

According to aspects of the invention, one or more concentrators 152 may be adapted for use with new installations, for example, new installations of photovoltaic (PV), that is, “solar” panels, or with existing installations. For example, aspects of the invention may be used to “retro fit” existing PV installations to enhance the collection of solar radiation.

Accordingly, in one aspect, concentrator 152 may be provided with new PV devices. For example, target 156 may be a newly fabricated array of PV devices, that is, a solar panel, and concentrator 152 (and any concentrator disclosed herein) may be mounted to the newly fabricated array, for example, by conventional means. In one aspect, concentrator 152 may be provided in an appropriate frame or structure and appropriately mounted to a new PV array, for example, by conventional mechanical fasteners or an adhesive

According in another aspect, concentrator 152 may be provided for existing PV devices. For example, target 156 may be an existing array of PV devices, that is, a solar panel, and concentrator 152 (and any concentrator disclosed herein) may be mounted to the existing array, for example, by conventional means. In one aspect, concentrator 152 may be provided in an appropriate frame or structure and appropriately mounted to an existing PV array, for example, by conventional mechanical fasteners or an adhesive. In another aspect, concentrator 152 (and any concentrator disclosed herein) may be overlaid onto existing PV arrays 156, for example, mounted with conventional mechanical fasteners or an adhesive

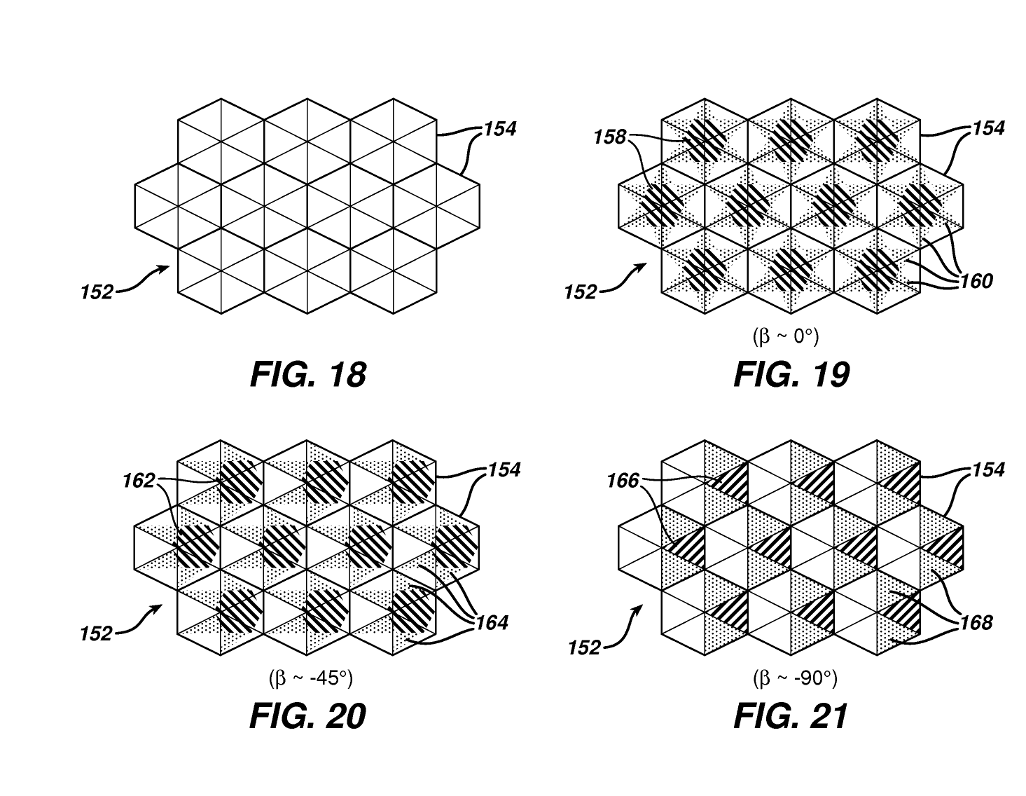

FIG. 18 is a top plan view of a portion of concentrator 152 having prism lenses 154 shown in FIG. 17. As shown in FIG. 18, according to one aspect of the invention, prism lenses 154 may be contiguous, for example, the shape of the base of prism lenses 154 (for example, the hexagonal shape in the aspect shown) engages adjacent prism lenses 154 wherein there are little or no gaps or separations between prism lenses 154. Accordingly, this contiguous arrangement of prism lenses 154 provides for substantially complete coverage of the surface of target 156, for example, with little or no interruption or “shadows” on the surface of target 156.

FIGS. 19, 20, and 21 are schematic illustrations of typical concentration patterns of incident radiation upon a target surface, for example, upon target 156 shown in FIG. 17, provided by aspects of the invention. The concentration patterns shown in FIGS. 19, 20, and 21 schematically represent patterns actually produced during testing of prototype versions of aspects of the present invention when exposed to sunlight. FIG. 19 is a schematic illustration of a concentration pattern produced when the incident solar radiation is substantially perpendicular to the plane of the bases of prism lenses 154 (for example, when the angle of orientation β of light rays is substantially zero degrees, see FIGS. 8 and 9, that is, substantially directly overhead). As shown in FIG. 19, when sunlight is directed substantially overhead, concentrator 152 concentrates the solar energy in hexagonal regions 158 on target 156. These hexagonal regions 158, the shape of which is understood to be a function of the hexagonal shape of prism lenses 154, are substantially centered about the axis or centerline of each prism lens 154. In addition, at least some sunlight is dispersed about hexagonal regions 158 in triangular regions 160. Again, the shape of these triangular regions 158 is understood to be a function of the hexagonal shape of prism lenses 154. (It is envisioned that the shapes and locations of regions 158 and 160 will vary with the shape of prism lenses 154.)

FIG. 20 is a schematic illustration of a concentration pattern produced when the incident solar radiation is about 45 degrees from perpendicular (for example, when the angle of orientation β of light rays is substantially minus 45 degrees, see FIGS. 8 and 9, that is, substantially between directly overhead and the horizon). As shown in FIG. 20, when sunlight is directed at about 45 degrees to the plane of the bases of prism lenses 154, concentrator 152 concentrates the solar energy in hexagonal regions 162 on target 156. These hexagon regions 162, which are understood to be a function of the hexagonal shape of prism lenses 154, are substantially located at a position displaced from the axis or centerline of each prism lens 154, in a direction opposite the direction of the source of the sunlight. In addition, at least some sunlight is dispersed about hexagonal regions 162 in triangular regions 164. Again, the shape of these triangular regions 164 is understood to be a function of the hexagonal shape of prism lenses 154. (It is envisioned that the shapes and locations of regions 162 and 164 will vary with the shape of prism lenses 154.)

FIG. 21 is a schematic illustration of a concentration pattern produced when the incident solar radiation is about 90 degrees from perpendicular (for example, when the angle of orientation β of light rays is substantially minus 90 degrees, see FIGS. 8 and 9, that is, substantially on the horizon). As shown in FIG. 21, when sunlight is directed at about 90 degrees to the plane of the bases of prism lenses 154, concentrator 152 concentrate the solar energy in triangular regions 166 on target 156. These triangular regions 166, which are understood to be a function of the hexagonal shape of prism lenses 154, are substantially located at a position displaced from the axis or centerline of each prism lens 154, in a direction opposite the direction of the source of the sunlight. In addition, at least some sunlight is dispersed about triangular regions 166 in triangular regions 168. Again, the shape of these triangular regions 168 is understood to be a function of the hexagonal shape of prism lenses 154. (It is envisioned that the shapes and locations of regions 166 and 168 will vary with the shape of prism lenses 154.)

The patterns and location of the areas on the target where radiation is concentrated as shown in FIGS. 19 through 21 illustrate that aspects of the invention can provide effective means of concentrating the energy of radiation. For example, aspects of the invention can concentrate solar radiation, regardless of the location of the sun throughout the day, relative to the location and orientation of the concentrator 152 and target 156.

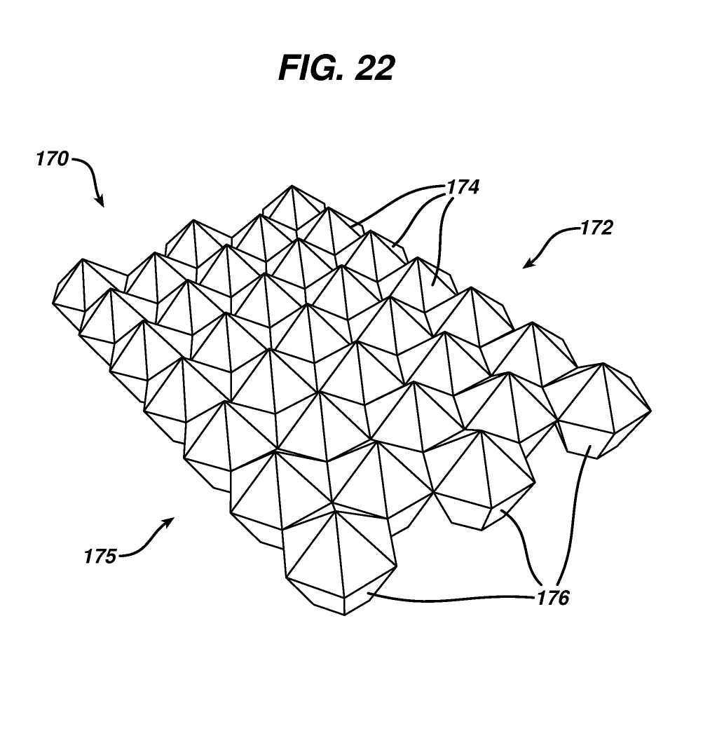

FIG. 22 is a perspective view of an arrangement 170 of an electromagnetic radiation concentrator 172 comprising an array of prism lenses 174 and an array 175 of reflector cavities 176 according to another aspect of the invention. Prism lenses 174 may comprise prism lenses 12 and/or prism lenses 42 disclosed herein. As will be discussed below, according to aspects of the invention, in the arrangement 170 shown in FIG. 22, prism lenses 174 and reflector cavities 176 can provide enhanced concentration of incident radiation, for example, solar energy, upon a target.

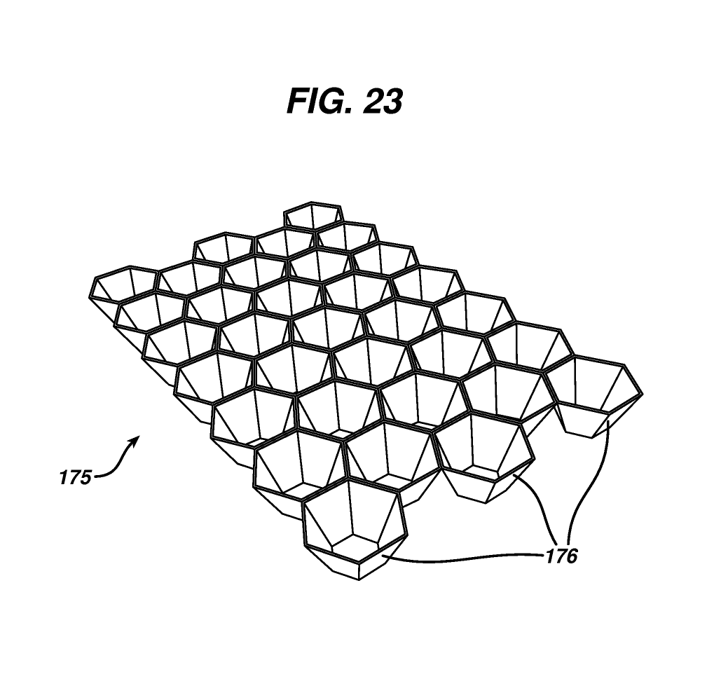

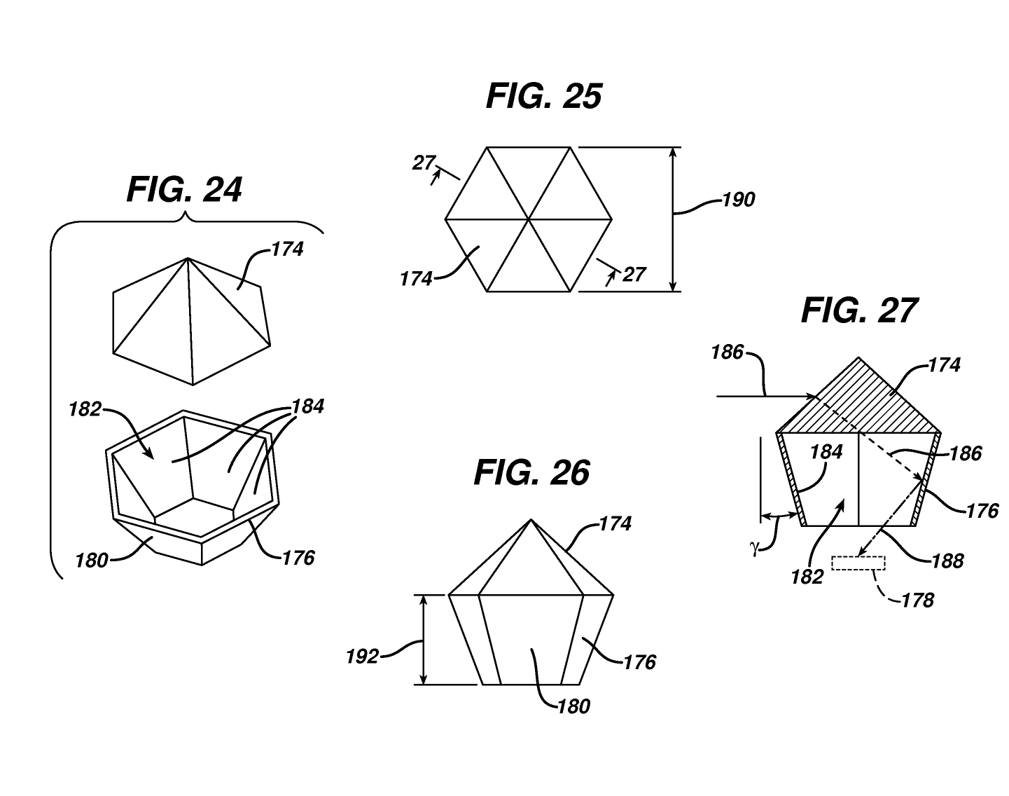

FIG. 23 is a perspective view of the array 175 of reflector cavities 176 shown in FIG. 22. FIG. 24 is an exploded perspective view of an arrangement of a prism lens 174 and a reflector cavity 176 shown in FIG. 22. FIG. 25 is a top plan view of the arrangement of prism lens 174 and reflector cavity 176 shown in FIG. 24. FIG. 26 is a front elevation view of the arrangement of prism lens 174 and reflector cavity 176 shown in FIG. 24. FIG. 27 is a cross sectional view of the arrangement of prism lens 174 and reflector cavity 176 shown in FIG. 24 as viewed along section lines 27-27 shown in FIG. 25, and illustrating typical paths of light rays upon a target 178 (shown in phantom) according to an aspect of the invention.

As shown in FIGS. 24 through 27, prism lens 174 may be similar in shape, size, function, and material to prism lens 12 or prim lens 42 disclosed herein. As also shown in FIGS. 24 through 27, reflector cavity 176 includes a housing 180 having an internal cavity 182 and at least one, but typically, a plurality of, reflective surfaces 184 arranged around the internal surfaces of internal cavity 182. Though housing 180 is shown abutting prism lens 174 in FIG. 27, it is envisioned that housing 180 may be displaced from prism lens 174, for example, to provide the desired deflection upon target 178. In one aspect, as shown in FIGS. 24-27, housing 180 may comprise a converging conical housing, for example, a converging frusto-conical housing providing frusto-conical shaped reflective surfaces 184.

As shown most clearly in FIG. 27, according to aspects of the invention, reflector cavity 176 is adapted to receive radiation rays 186, for example, sunlight, that have been refracted by prism lens 174 from incident light rays 184, and reflect and direct the reflected light ray 188 upon target 178. It is to be understood that the refraction and reflection of incident ray 184 shown in FIG. 27 represents only a single example of the numerous rays of electromagnetic radiation, for example, sunlight, that may typically impact concentrator 172 and produce numerous multiple refracted rays 186 and reflected rays 188 upon target 178.

In the aspect of the invention shown in FIGS. 24 through 27, reflector cavity 176 is shown as having a six-sided housing 180 having planar internal reflecting surfaces 184. However, in other aspects, housing 180 may have 1 or more sides and 1 or more reflecting surfaces 184, for example, depending upon the shape of the prism lens 174 with which reflector cavity 176 is used. In one aspect, housing 180 may have 4 or more surfaces 184, or 8 or more surfaces 184, or 12 or more surfaces 184.

As shown in FIGS. 24 through 27, reflective surfaces 184 may typically be oriented or inclined to provide the desired direction of reflection. For example, surfaces 184 may be oriented at an angle γ, as shown most clearly in FIG. 27. The angle γ may vary broadly depending upon the application of reflector cavity 176, prism lens 174, and the direction of incident rays 184. In one aspect, angle γ may range from about 0.5 degrees to about 60 degrees, but typically ranges from about 10 degrees and about 45 degrees, for example, about 20 degrees.

The size of reflector cavity 176 may vary broadly depending upon the nature of the application for which prism lens 174 and reflector cavity 176 are used, for example, for a “nano”-scale, “micro”-scale, or “macro”-scale application. For example, as shown in FIGS. 25 and 26, the width 190 of reflector cavity 176 may range from about 0.1 nm to about 1 m. However, in some applications, the width 190 may range from about 0.1 μm to about 1 mm, while in other applications, width 190 may range from about 2 mm to about 100 mm, for example, about 5 mm to about 50 mm.

The height 192 of reflector cavity 176 may range from about 0.1 nm to about 1 m. However, in some applications the height 192 may range from about 0.1 μm to about 1 mm, while in other applications, height 192 may range from about 2 mm to about 100 mm, for example, about 5 to about 50 mm. According to aspects of the invention, reflector cavity 176 may be fabricated from any suitable material, for example, a metal, a plastic, a glass, or even wood. In one aspect, reflector cavity 176 may be made from a plastic, for example, a poly methyl methacrylate (PMMA), an acrylic, a polycarbonate, a polyester, a fluorocarbon, a polyimide, or a polyethersulfone, among other at least partially transparent plastics or polymers that may be used to provide aspects of the invention. Reflective surfaces 184 may comprise any material at least partially reflective to the light ray 186 refracted by prism lens 174. However, in one aspect, reflective surfaces 186 may typically be substantially completely reflective to light ray 186. In one aspect, the one or more reflective surfaces 184 may be made from a polymer or glass sheet having a reflective film, for example, a polyethylene terephthalate (PET) sheet, such as, a MYLAR® PET sheet, having a metallized or dielectric reflective film (for example, aluminum, silver, or gold, for instance, deposited by vapor deposition), or a glass having a metallized reflective film, or their equivalent.

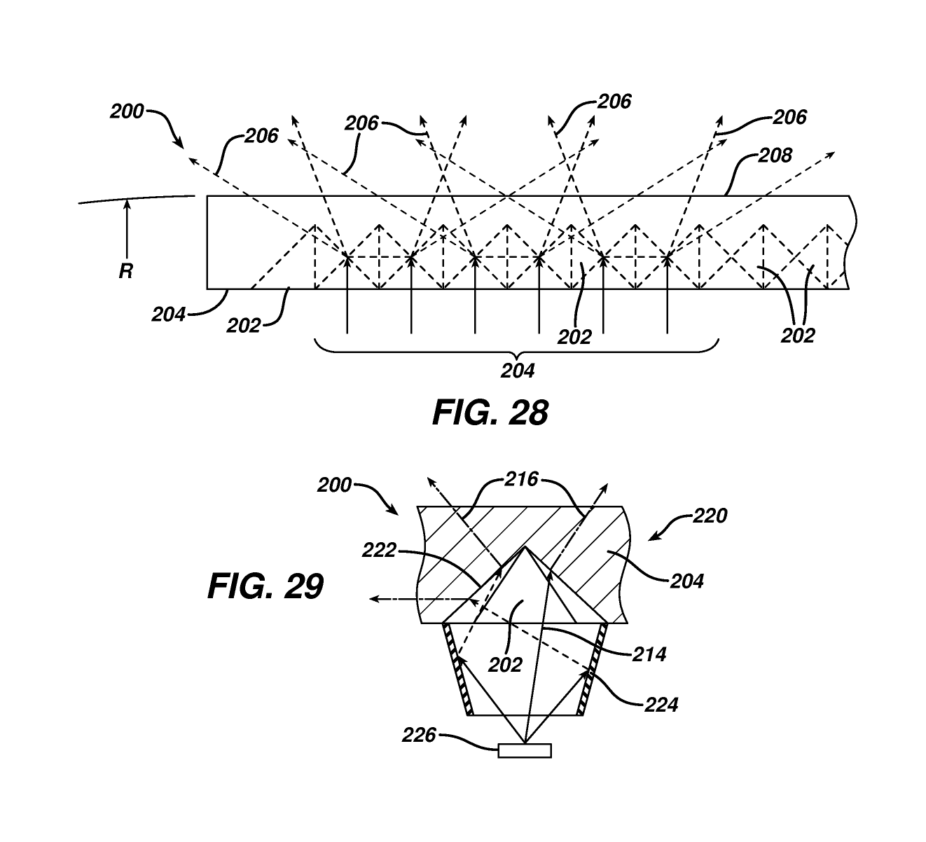

FIG. 28 is a partial front elevation view of an electromagnetic radiation diffuser or disperser 200 according to another aspect of the invention. According to this aspect of the invention, instead of concentrating radiation, for example, visible light, with the use of prism lenses, diffuser 200 may be used to receive and disperse radiation using an array of prism lens-shaped cavities or depressions 202 in a panel or plate 204. In a fashion similar to the arrays of prism lenses disclosed herein, the array of prism-lens shaped cavities or depressions 202 may be a planar array or a curvilinear, for example, circular cylindrical, array of cavities or depressions 202.

As shown in FIG. 28, diffuser 200 may include an array of prism lens-shaped cavities 202, for example, shaped similarly to prism lenses 12 shown and described with respect to FIGS. 2 through 6. According to aspects of the invention, prism lens-shaped cavities 202 are positioned and adapted to receive incoming radiation 204, for example, from a light source, and via one or more refractions disperse radiation as rays 206. Prism lens-shaped cavities 202 may comprise 3 or more planar surfaces, for example, 6 planar surfaces, and have similar sizes, and shapes, as prism lenses 12, 42, and others disclosed herein. Plate or panel 204 may be provided by any one or more of the at least partially transparent materials disclosed herein, for example, PMMA.

According to aspects of the invention, plate or panel 204 may have a substantially planar upper surface 208. However, in some aspects of the invention surface 208 may be radiused, for example, having a constant radius of curvature R shown in FIG. 28. The radiused surface 208 may provide some enhancement to the dispersion of the radiation. The radius of curvature R may vary broadly deepening upon the size, use, and features of diffuser 200.

As shown in FIG. 28, according to an aspect of the invention, one or more representative incident radiation rays 204, for example, from one or more LED sources, contact and are refracted by a prism lens-shaped cavities 202 of diffuser 200 to produce at least one refracted radiation ray 206. Refracted ray 206 is directed as desired, for example, upon target to be illuminated (not shown). In addition to refracting the incident rays 204, prism lens-shaped cavities 202 may also reflect incident rays 204 to produce one or more reflected rays (not shown). The one or more the reflected rays may contact one or more adjacent prism lens-shaped cavities 202 and produce one or more further refracted rays (not shown). Accordingly, according to aspects of the invention, prism lenses 202 of diffuser 200 may repeatedly refract and reflect incident rays 204 to produce multiple refracted rays 206 to be directed as desired. It is to be understood that the refraction and reflection of incident rays 204 shown in FIG. 28 represent only examples of the numerous rays of electromagnetic radiation, for example, LED or laser light, that may typically impact diffuser 200 and produce numerous multiple refracted rays 206.

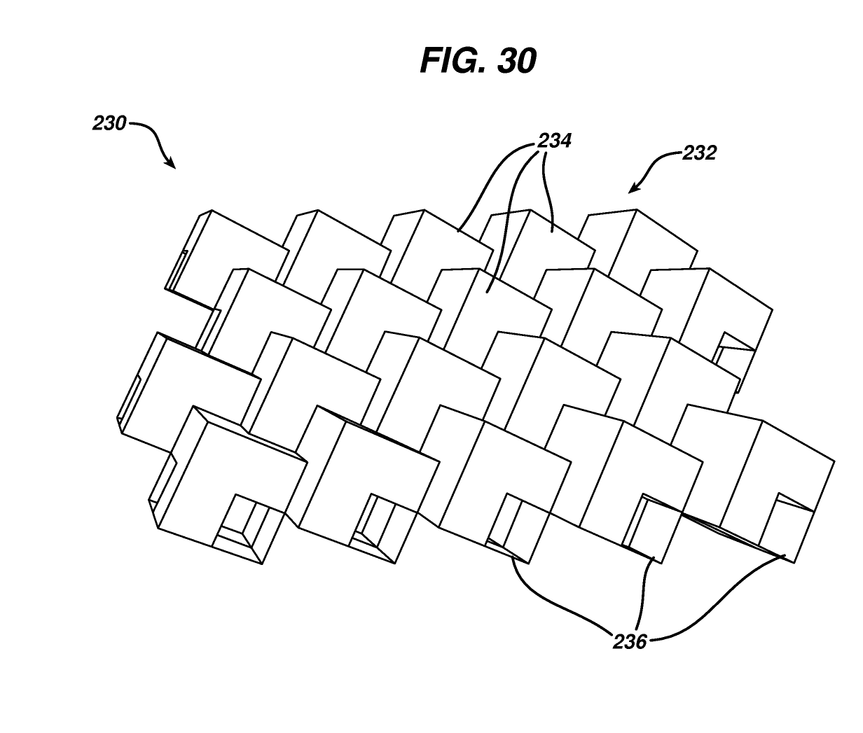

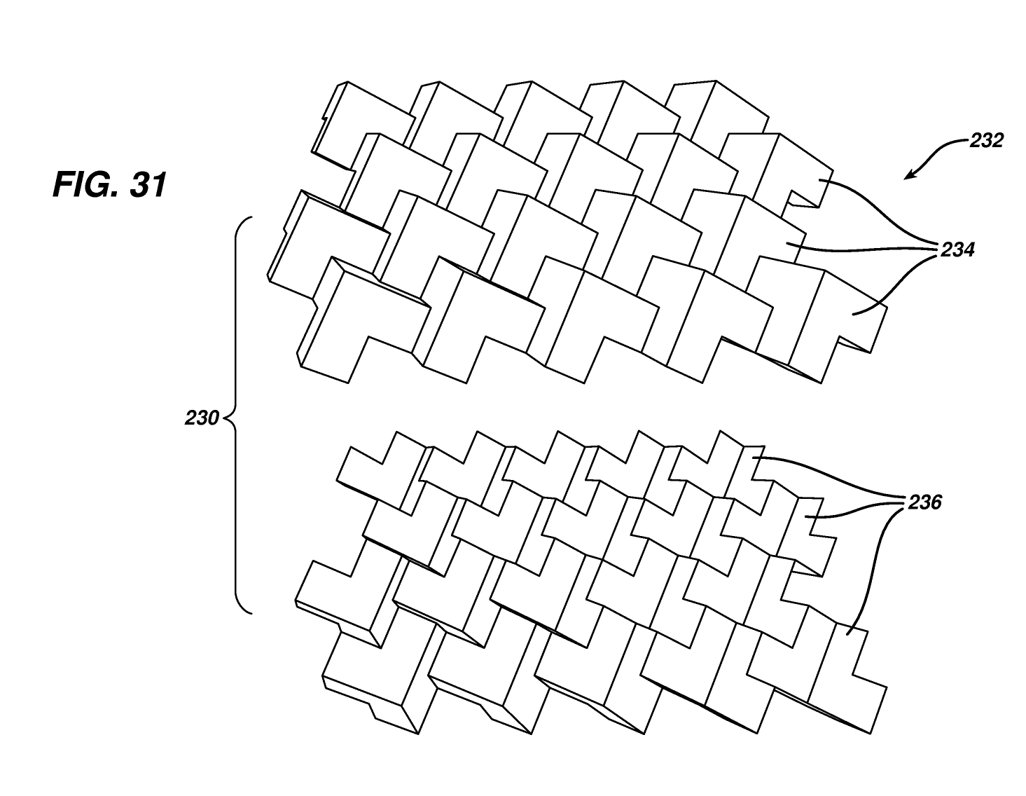

FIG. 29 is a partial cross sectional front elevation view of an arrangement 220 of electromagnetic radiation diffuser or disperser 200 (shown in FIG. 28) and one reflector cavity 224 of an array of reflector cavities that may be used to disperse light according to another aspect of the invention. According to this aspect of the invention, diffuser 200 may include an array of lens-shaped cavities 222. According to aspects of the invention, prism lens-shaped cavities 202 are positioned and adapted to receive incoming radiation 214, for example, from a light source 226, and via one or more refractions disperse radiation as rays 216. Prism lens-shaped cavities 222 may have similar sizes and shapes as prism lenses 12, 42, and others disclosed herein.

As also shown in FIG. 29, arrangement 220 includes reflector cavity 224 of an array of reflector cavities. According to this aspect of the invention, one or more reflector cavities 224 are used to enhance the light captured from one or more sources 226 and directed to one or more prism lens-shaped cavities 222 in radiation diffuser 200. Similar to the function of reflector cavity 176 shown and described with respect to FIG. 27, reflector cavity 224 shown in FIG. 29 includes one or more internal reflective surfaces positioned and oriented to receive and reflect radiation from source 226 and direct reflected radiation upon prism lens-shaped cavity 222 for refraction and dispersion as desired.

Prism lens-shaped cavities 222 may be shaped similar to one of the prism lenses 12 or 42 disclosed herein. Reflector cavity 224 may be one of the reflector cavities 176 disclosed herein. According to aspects of the invention, source 226 may be any source of electromagnetic radiation that can be reflected by reflector cavity 224 and refracted by prism lens-shaped cavity 222. For example, according to aspects of the invention, source 226 may be one or more lasers, one or more light-emitting diodes (LEDs), one or more incandescent light sources, one or more fluorescent light sources, or sunlight, among other light sources.

FIG. 30 is a perspective view of an arrangement 230 of an electromagnetic radiation concentrator 232 comprising an array of prism lenses 234 and an array of reflector cavities 236 according to another aspect of the invention. In the arrangement 230 shown in FIG. 30, prism lenses 234 and reflector cavities 236 can provide enhanced concentration of incident radiation, for example, solar energy, upon a target. FIG. 31 is an exploded perspective view of the arrangement 230 shown in FIG. 30.

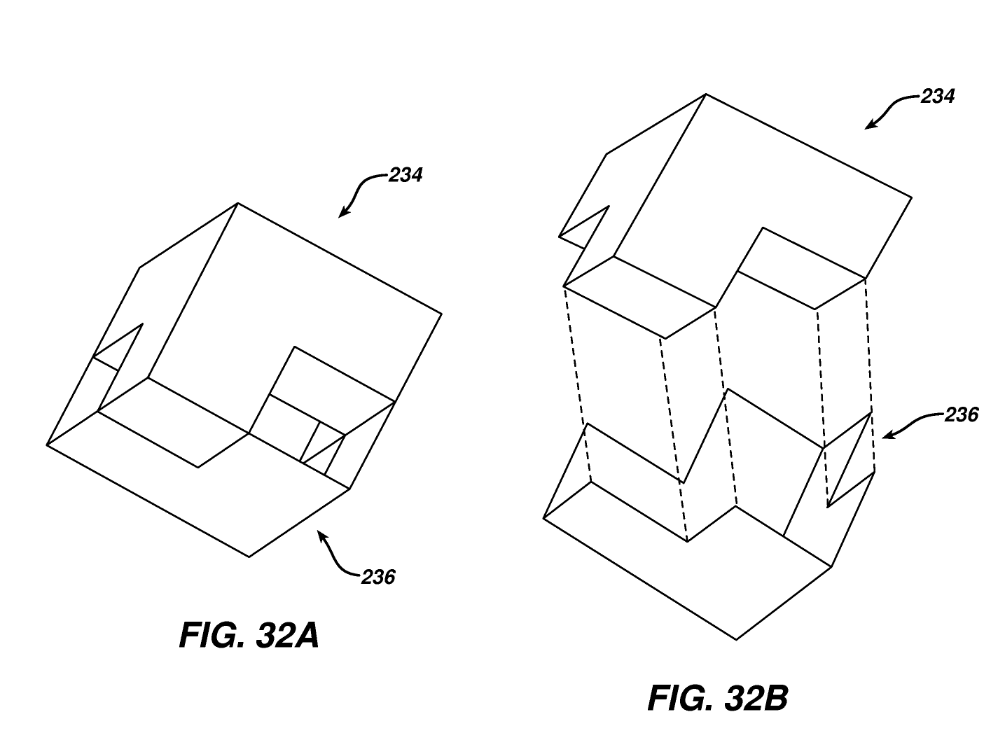

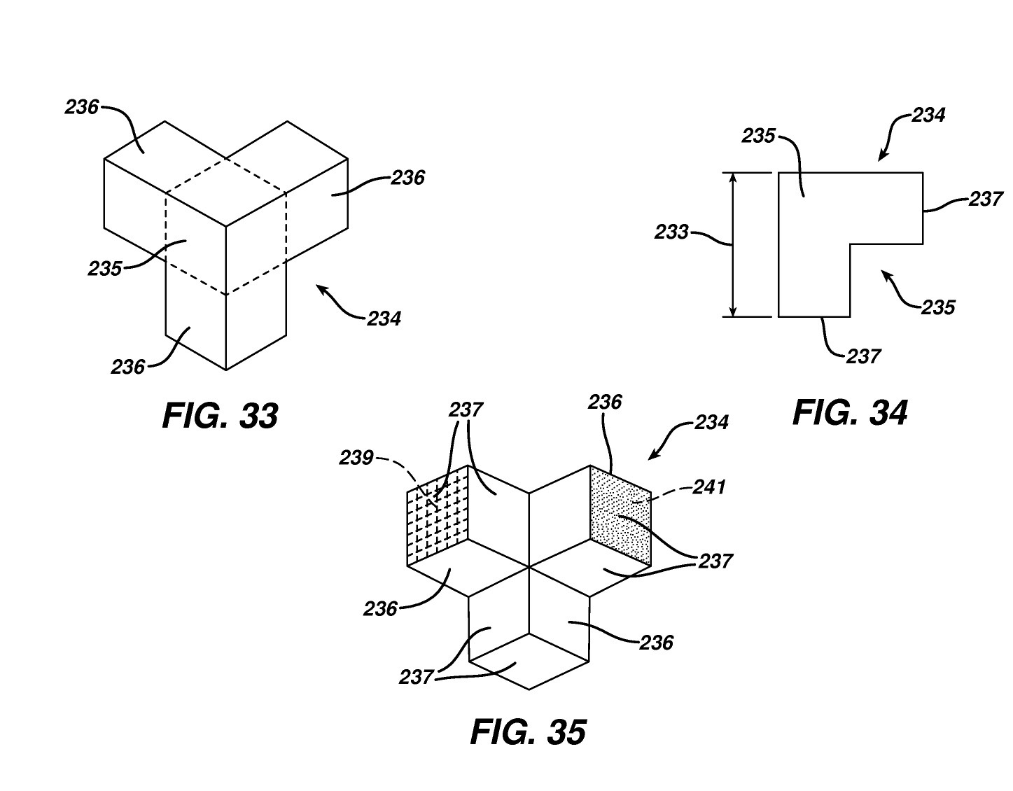

FIG. 32A is a perspective view of an assembly of a prism lens 234 and a reflector cavity 236 shown in FIG. 31 and FIG. 32B is an exploded perspective view of the assembly of a prism lens 234 and reflector cavity 236 shown in FIG. 32A. FIG. 33 is a front perspective view of prism lens 234 shown in FIG. 32B. FIG. 34 is a right-side side elevation view of prism lens 234 shown in FIG. 33, the left side elevation view being a mirror image thereof, and the top plan view being a 135 degree counter-clockwise rotation thereof. FIG. 35 is a rear perspective view of prism lens 234 shown in FIG. 33.

As shown in FIG. 33, prism lens 234 may typically have a generally pyramidal shaped main body 235, and a plurality of protections, or “legs,” 236 projecting from main body 235. As shown most clearly in FIG. 35, projections or legs 236 include a plurality of faces 237, for example, planar faces, 238. According to aspects of the invention, one or more faces 237 of projections 236 may be provided with a target 239, for example, one or more photovoltaic devices. In one aspect, each of the distal faces of projections 236 may comprise at least some PV devices, for example, the three distal faces shown in FIG. 35 may have PV devices.

In another aspect, one or more faces 237 of projections 236 may be provided with a reflective surface 241, for example, having one of the reflective materials described herein. Though shown as what may appear as an external surface in FIG. 35, it is to be understood that reflective surface 241, and other similar reflective surfaces, may comprise and internal reflective surface, for example, a reflective surfaces that reflects light within prism lens 234. In one aspect, each of the distal faces of projections 236 may comprise a reflective surface 241, for example, the three distal faces shown in FIG. 35. According to this aspect, one or more reflective faces 241 may be adapted to reflect light onto a target, for example, upon a target 239 on a face 237 of a projection 236. In another aspect, at least one of the faces 237 may be provided with a target 239 and at least one of the faces 237 may be provided with reflective material 241. In one aspect, when prism lens 234 comprises three projections 236, one distal face of a projection may comprise a target 239 and the two remaining distal faces comprise reflective material 241.

The size of prism lens 234 may vary broadly depending upon the nature of the application for which lens 234 is used, for example, for a “nano”-scale, “micro”-scale, or “macro”-scale application. For example, the width or height 233 of prism lens 234, shown in FIG. 34, may range from about 0.1 nm to about 1 m. However, in some applications, the width 233 may range from about 0.1 μm to about 1 mm, while in other applications, width 233 may range from about 2 mm to about 100 mm, for example, about 5 mm to about 50 mm.

According to aspects of the invention, the material of prism lens 234 may be at least partially transparent to the electromagnetic radiation begin handled, for example, visible light, such as, sunlight. Preferably, the material for prism lens 234 may be substantially completely transparent to the radiation being handled. In one aspect, prism lens 234 may be made from a glass, for example, optical glass, tempered glass, heat treated glass, or their equivalent. In another aspect, prism lens 234 may be made from a plastic, for example, a poly methyl methacrylate (PMMA), an acrylic, a polycarbonate (PC), a polyester, a fluorocarbon, a polyimide, or a polyethersulfone, among other at least partially transparent plastics or polymers that may be used to provide aspects of the invention.

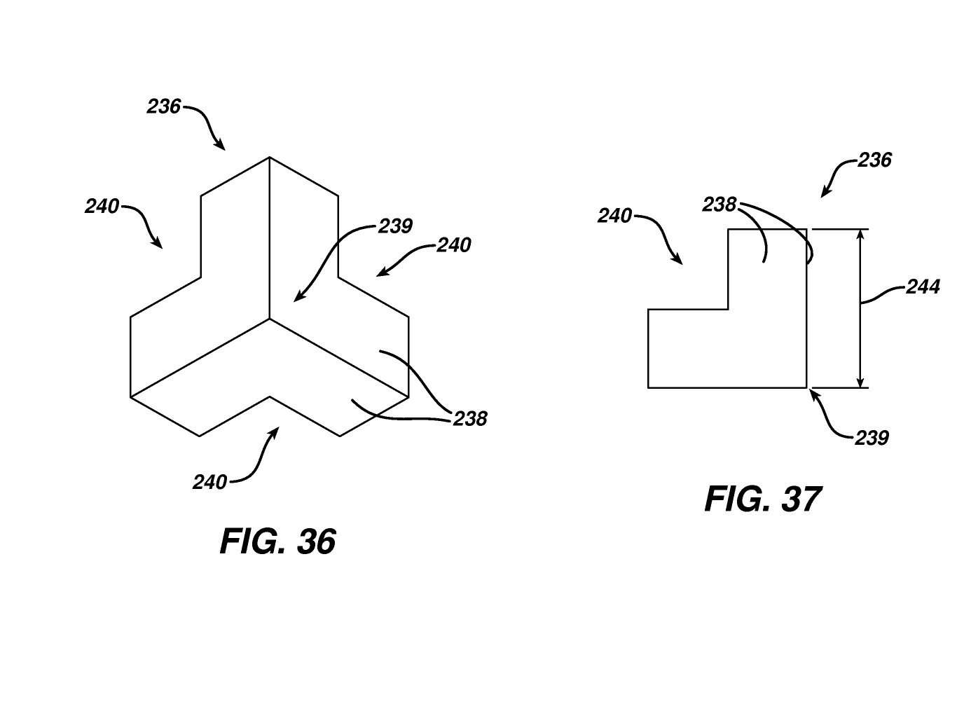

FIG. 36 is a perspective view of reflector cavity 236 shown in FIG. 32B. FIG. 37 is a right-side elevation view of reflector cavity 236 shown in FIG. 32B, the left side elevation view being a mirror image thereof, and the top plan view being a 135-degree counter-clockwise rotation thereof.

As shown in FIG. 36, reflector cavity 236 may typically comprise three planar walls 238 converging to an apex 239 and having a recess 240 in each planar wall 238. Recess 240 may be sized and position to receive prism lens 234. According to aspects of the invention, at least one of walls 238 of reflector cavity 236 comprise a reflective material, for example, one of the reflective materials disclosed herein. In one aspect, at least one of walls 238 of reflector cavity 236 may comprise a target (not shown), for example, one or more PV devices. According to this aspect, the one or more walls 238 may be adapted to reflect light, for example, light received from prism lens 136, onto a target, for example, upon a PV device on a wall 238-reflector cavity 236.

The size of reflector cavity 236 may vary broadly depending upon the nature of the application for which prism lens 234 and reflector cavity 236 are used, for example, for a “nano”-scale, “micro”-scale, or “macro”-scale application. For example, the width or height 244 of reflector cavity 236 may range from about 0.1 nm to about 1 m. However, in some applications, the width 244 may range from about 0.1 μm to about 1 mm, while in other applications, width 244 may range from about 2 mm to about 100 mm, for example, about 5 mm to about 50 mm.

According to aspects of the invention, reflector cavity 236 may be fabricated from any suitable material, for example, a metal, a plastic, a glass, or even wood. In one aspect, reflector cavity 236 may be made from a plastic, for example, a poly methyl methacrylate (PMMA), an acrylic, a polycarbonate (PC), a polyester, a fluorocarbon, a polyethylene, a polyimide, or a polyethersulfone, among other at least partially transparent plastics or polymers, for example, metal-coated plastics or polymers, that may be used to provide aspects of the invention. The surfaces of walls 238 of reflector cavity 236 may be reflective, for example, comprise any material at least partially reflective to the light rays refracted by prism lens 234. However, in one aspect, surfaces of walls 238 may typically be substantially completely reflective to the incident radiation, such as, sunlight. In one aspect, the surfaces of walls 238 may be made from a polymer having a reflective coating, such as, a polyethylene terephthalate (PET) sheet, such as, a MYLAR® PET sheet, having, for example, a metallized or dielectric reflective film (for example, aluminum, silver, or gold, for instance, deposited by vapor deposition), a metalized polymer, or their equivalent.

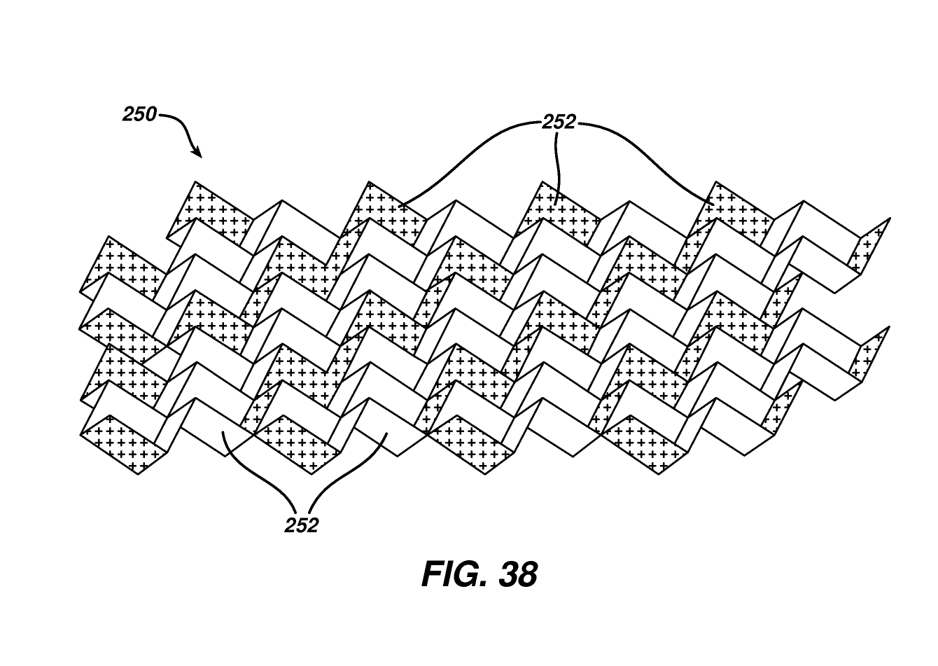

FIG. 38 is a perspective view of array 250 of reflector cavities 252 that may be used in arrangement 230 according to another aspect of the invention. In a manner similar to the array of reflector cavities 236 shown in FIGS. 30 and 31, array 250 of reflector cavities 252 may be used in conjunction with the array of prism lenses 234 shown in FIGS. 30 and 31.

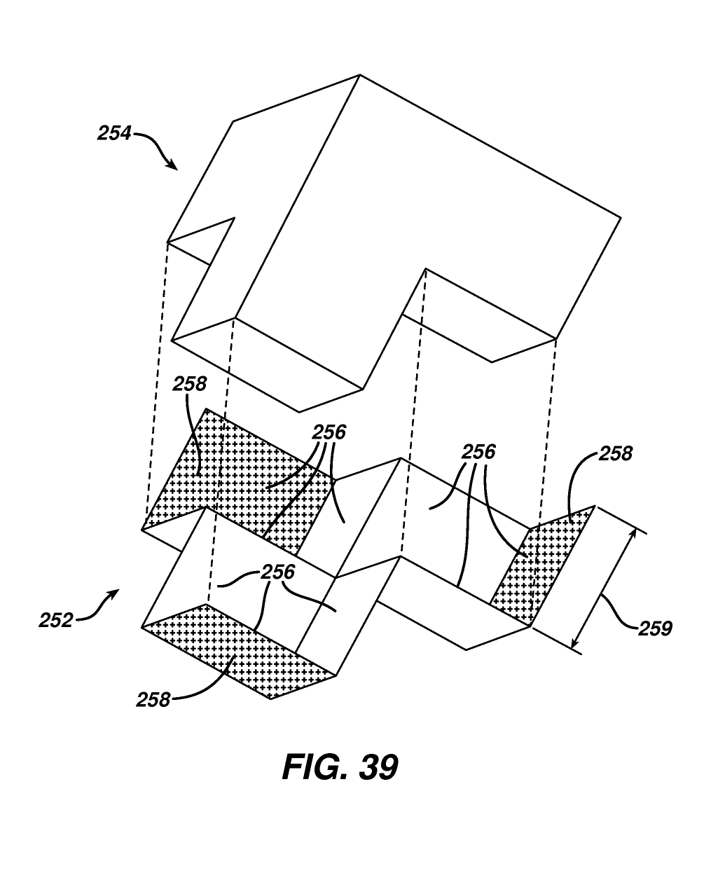

FIG. 39 is an exploded perspective view of arrangement of a prism lens 254 and a reflector cavity 252 as shown in FIG. 38. Prism lens 254 may be similar or identical to prism lens 234 described above. As shown in FIG. 39, reflector cavity 252 may comprise a series of planar surfaces 256 shaped and positioned to mate or correspond with the surfaces of prism lens 254. Surfaces 256 may be substantially perpendicular to adjacent surfaces 256. According to aspects of the invention, at least one of surfaces 256 of reflector cavity 252 comprises a reflective material, for example, one of the reflective materials disclosed herein. In one aspect, at least one of surface 256 of reflector cavity 252 may comprise a target 258 for example, one or more PV devices. According to this aspect, the one or more surfaces 256 may be adapted to reflect light, for example, light received from prism lens 254, onto a target, for example, upon a PV devices 258 on a surface 256 of reflector cavity 252.

The size of reflector cavity 252 may vary broadly depending upon the nature of the application for which prism lens 254 and reflector cavity 252 are used, for example, for a “nano”-scale, “micro”-scale, or “macro”-scale application. For example, the width 259 of surfaces 258 may range from about 0.1 nm to about 1 m. However, in some applications, the width 259 may range from about 0.1 μm to about 1 mm, while in other applications, width 259 may range from about 2 mm to about 100 mm, for example, about 5 mm to about 50 mm.

According to aspects of the invention, reflector cavity 252 may be fabricated from any suitable material, for example, a metal, a plastic, a glass, or even wood. In one aspect, reflector cavity 252 may be made from a plastic, for example, a poly methyl methacrylate (PMMA), an acrylic, a polycarbonate (PC), a polyester, a fluorocarbon, a polyethylene, a polyimide, or a polyethersulfone, among other plastics or polymers, for example, metal-coated plastics or polymers, that may be used to provide aspects of the invention.

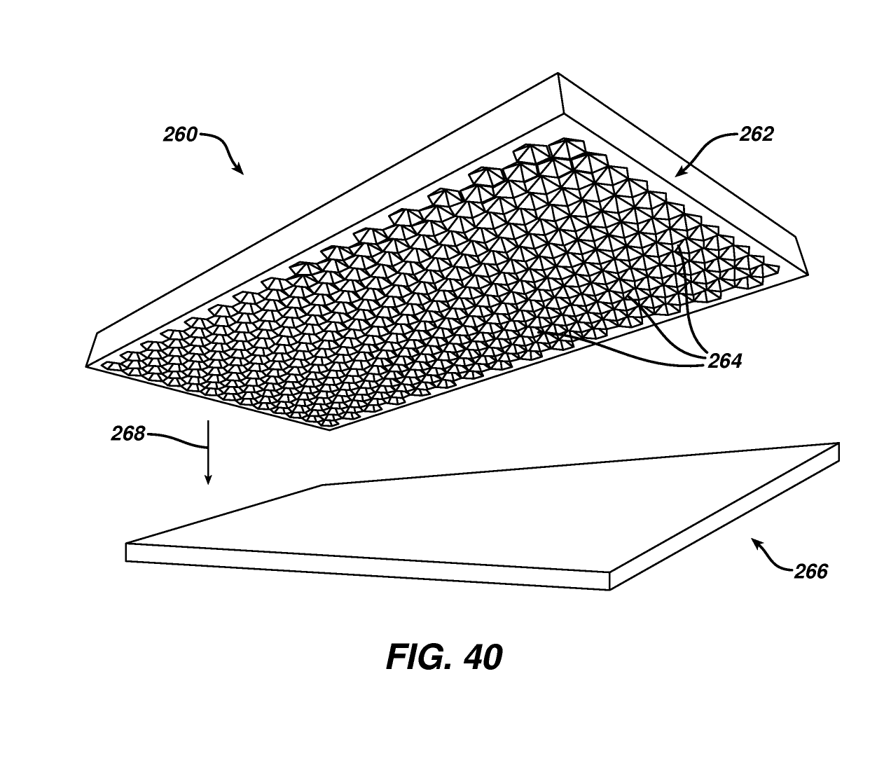

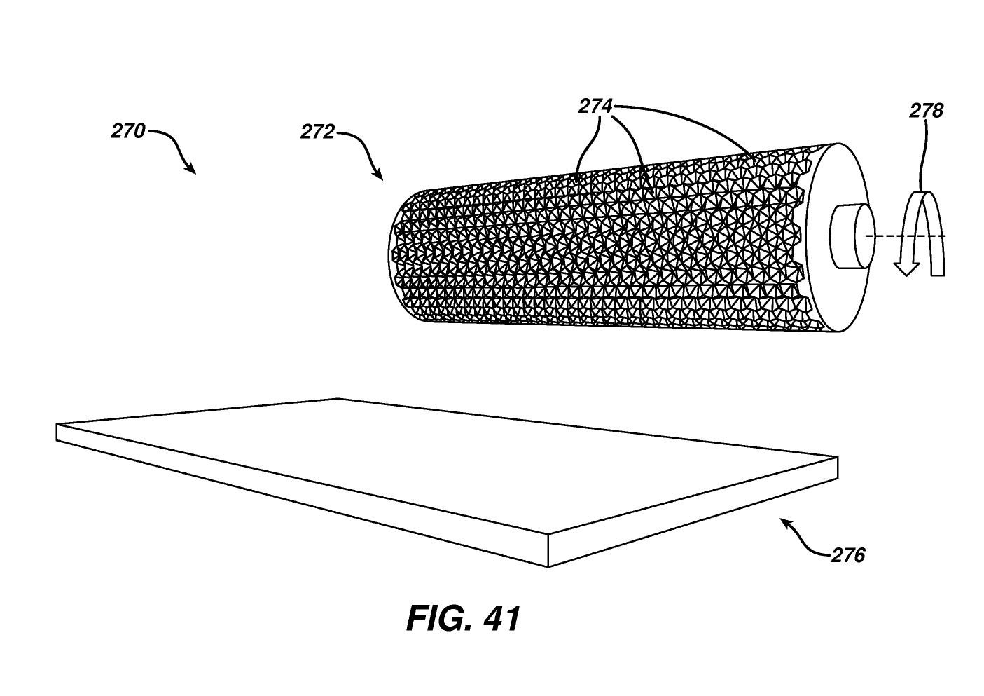

FIGS. 40 and 41 illustrate typical apparatus and methods that may be used to fabricate arrays of prism elements and/or light diffusers according to aspects of the invention. FIG. 40 is a perspective view of one apparatus or molding device 260 that may be used to fabricate aspects of the invention. As shown in FIG. 40, apparatus 260 includes a planar mold or platen 262 having a plurality of recesses, cavities, indentations, or projections 264 defining the surfaces of any one or more of the prism lenses or diffuser cavities disclosed herein. For example, cavities 264 may provide a mold of the surfaces of prism lens 12 or prism lens 42 disclosed herein, or projections 264 may provide a mold for the prism lens shaped cavities in diffuser 200. According to aspects of the invention, planar mold 262 is engaged with, as indicated by arrow 268, a plate or sheet or reservoir of flowable, hardenable material 266, for example, where each of the cavities 264 are substantially filled with flowable hardenable material 266 or projections 264 are embedded into flowable hardenable material 266. The flowable hardenable material 266 may be a PMMA, an acrylic, a polyester, a fluorocarbon, a polyimide, or a polyethersulfone, among other plastics or polymers, or a glass. During or after sufficient engagement of mold 262 with material 266, material 266 is allowed to harden to form the desired array of prism lenses or cavities.

FIG. 41 is a perspective view of another apparatus or molding device 270 that may be used to fabricate aspects of the invention according to one aspect of the invention. As shown in FIG. 41, apparatus 270 includes a cylindrical mold 272 having a plurality of recesses, cavities, indentations, or projections 274 defining the surfaces of any one or more of the prism lenses or diffuser cavities disclosed herein. For example, cavities 264 may provide a mold of the surfaces of prism lens 12 or prism lens 42 disclosed herein, or projections 274 may provide a mold for the prism lens shaped cavities in diffuser 200. According to aspects of the invention, cylindrical mold 272 is rotatably engaged, as indicated by curved arrow 278, with a plate or sheet or reservoir of flowable, hardenable material 276, for example, where each of the cavities 274 are substantially filled with flowable hardenable material 276 or projections 274 are embedded into flowable hardenable material 276. The flowable hardenable material 266 may be PMMA, an acrylic, or a glass, or any one of the flowable hardenable material referenced above with respect to material 266. During or after sufficient engagement of mold 272 with material 276, material 276 is allowed to harden to form the desired array of prism lenses or cavities.

Accordingly, the above disclosure makes it clear that embodiments of the present invention provide solar radiation concentrators, methods of concentrating solar radiation and solar radiation concentrating lens prisms, among over things, that provide advantages and improvements over the prior art. For example, aspects of the present invention may provide improvements to existing solar panels installations or enhance newly fabricated installations. Aspects of the invention disclosed herein can be used for enhancing the capturing of energy for both passive and active solar systems. For example, aspects of the invention may be used for collecting solar thermal radiation or for PV electrical energy production.

While several aspects of the present invention have been described and depicted herein, alternative aspects may be affected by those skilled in the art to accomplish the same objectives. Accordingly, it is intended by the appended claims to cover all such alternative aspects as fall within the true spirit and scope of the invention.

1. A solar radiation concentrator comprising:
an array of prism lenses, each of the prism lenses comprising a solar radiation transmissible material and a plurality of converging planar sides;
wherein each of the plurality of planar sides of each of the prism lenses defines a refractive surface positioned to receive and refract incident solar radiation and direct at least some of the incident radiation upon a target.

2. The concentrator as recited in claim 1, wherein the plurality of converging planar sides comprises at least 3 converging planar sides.

3. The concentrator as recited in claim 1, wherein the plurality of converging planar sides consists of 6 converging planar sides.

4. (canceled)

5. (canceled)

6. The concentrator as recited in claim 1, wherein the array of prism lenses comprises an array of contiguous prism lenses.

7. The concentrator as recited in claim 6, wherein the array of contiguous prism lenses eliminates any non-contiguous regions.

8. (canceled)

9. The concentrator as recited in claim 1, wherein each of the plurality of converging planar sides converges at an angle.

10. The concentrator as recited in claim 9, wherein the angle ranges from 30 degrees to 60 degrees.

11-30. (canceled)

31. A solar radiation concentrating arrangement comprising:
an array of prism lenses, each of the prism lenses comprising a solar radiation transmissible material and a plurality of converging planar sides, and each of the plurality of converging planar sides of each of the prism lenses defines a refractive surface positioned to receive and refract incident solar radiation and direct at least some of the incident solar radiation upon a target; and
an array of reflector cavities, each of the reflector cavities having a plurality of reflective surfaces positioned to reflect at least some solar radiation diffracted by at least some of the prism lenses upon the target.

32. The arrangement as recited in claim 31, wherein the plurality of converging planar sides comprises at least 3 converging planar sides.

33. The arrangement as recited in claim 31, wherein the plurality of converging planar sides consists of 6 converging planar sides.

34. (canceled)

35. (canceled)

36. The arrangement as recited in claim 31, wherein the array of prism lenses comprises an array of contiguous prism lenses.

37. The arrangement as recited in claim 36, wherein the array of contiguous prism lenses eliminates any non-contiguous regions.

38. (canceled)

39. The arrangement as recited in claim 31, wherein each of the plurality of converging planar sides converges at an angle.

40. The arrangement as recited in claim 39, wherein the angle ranges from 30 degrees to 60 degrees.

41-50. (canceled)

51. A solar radiation concentrating prism lens comprising:
a pyramidal main body having a plurality of converging planar sides and a base;
wherein each of the plurality of converging planar sides defines a refractive surface positioned to receive and refract incident solar radiation and direct at least some of the incident radiation upon a target.

52. The prism lens as recited in claim 51, wherein the prism lens further comprises a plurality of polygonal protections projecting from the base.

53. The prism lens as recited in claim 51, wherein the plurality of convergent planar sides comprises at least 3 convergent planar sides.

54. (canceled)

55. The prism lens as recited in claim 51, wherein the plurality of convergent planar sides consist of 6 convergent planar sides.

56-59. (canceled)

60. The prism lens as recited in claim 51, wherein each of the plurality of converging planar sides converges at an angle.

61. The prism lens as recited in claim 60, wherein the angle ranges from 30 degrees to 60 degrees.

62-64. (canceled)
